(19) United States
(12) Patent Application Publication
(10) Pub. No.: US 2026/0139335 A1
(43) Pub. Date: May 21, 2026

(54) LEATHER DECORATING DEVICE AND METHOD

(71) Applicant: 21Grams Leather Goods LLC, Riverside, CA (US)

(72) Inventor: Dennis Forrester, Riverside, CA (US)

(21) Appl. No.: 19/395,157

(22) Filed: Nov. 20, 2025

Related U.S. Application Data
(60) Provisional application No. 63/722,895, filed on Nov. 20, 2024.

(51) Int. Cl. C14B 1/56

(52) U.S. Cl. CPC C14B 1/56

(57) ABSTRACT

A device for decorating leather that includes a cartridge that has a distal end, a shaft that has a proximal portion and a distal portion, the distal portion has a distal tip configured to tool leather and the proximal portion extends from the distal portion in a longitudinal direction. The device also has a drive that is configured to move the shaft in a reciprocating motion, and a drive housing configured to house the drive and be held by a user. If the device is assembled, the shaft is housed within the cartridge, the distal tip of the shaft extends distally beyond the distal end of the cartridge, and the cartridge is attached to the drive housing.

### CROSS REFERENCE TO RELATED APPLICATION

This application claims priority to U.S. Provisional Patent Application No. 63/722,895 entitled “LEATHER TOOLING DEVICE AND METHOD,” filed on Nov. 20, 2024, which is incorporated herein by reference in its entirety.

### FIELD OF THE INVENTION

The invention relates generally to a device and method of stamping leather that may be used to decorate leather or leather goods.

### BACKGROUND OF THE INVENTION

Leather tooling is a craft that involves decorating the surface of leather by carving, stamping, or embossing designs into it. This process not only enhances the aesthetic appeal of leather items but also adds texture and depth. Leather tooling requires a combination of artistic skill and technical proficiency. Conventional leather tooling requires mastery of a swivel knife and stamping tools. This required mastery poses a barrier to novices who may possess the inclination to tool leather but not the expertise. Practice and patience are key to developing the precision and control needed for conventional leather tooling. Often a mallet is used to strike the tools which requires a level of manual dexterity and physical ability that not all possess. Conventional leather tooling using manual tools can be tiring, and individuals with conditions such as arthritis or carpel tunnel may not be able to tool manually.

### SUMMARY

The following presents a simplified summary to provide a basic understanding of some aspects of the disclosed subject matter. This summary is intended to neither identify key or critical elements nor define any limitations of embodiments or claims. Furthermore, this summary may provide a simplified overview of some aspects that may be described in greater detail in other portions of this disclosure.

According to one aspect, a device comprises a cartridge that has a distal end, a shaft housed within the cartridge, wherein the shaft has a proximal portion and a distal portion, the distal portion has a distal tip, and the proximal portion extends from the distal portion in a longitudinal direction; and a drive that moves the shaft in a reciprocating motion, wherein the distal tip of the shaft extends beyond the distal end of the cartridge.

According to another aspect, a device for decorating leather comprising a cartridge that has a distal end, a shaft that has a proximal portion and a distal portion, the distal portion has a distal tip configured to tool leather and the proximal portion extends from the distal portion in a longitudinal direction. The device also has a drive that is configured to move the shaft in a reciprocating motion, and a drive housing configured to house the drive and be held by a user. If the device is assembled, the shaft is housed within the cartridge, the distal tip of the shaft extends distally beyond the distal end of the cartridge, and the cartridge is attached to the drive housing.

According to another aspect, a cartridge assembly for a leather-decorating tool, comprising a cartridge having a proximal end configured to couple to a body housing and a distal end configured to be positioned adjacent a leather work surface, and a shaft disposed within the body housing and movable along a longitudinal axis between a retracted position and an extended position. The cartridge includes a distal portion of the shaft that is configured as a distal tip carried by, when extended, to project distally beyond the distal end of the cartridge to deform a leather without cutting; and a return bias element within the cartridge engaging the shaft and urging the shaft toward the retracted position. The proximal end of the cartridge includes a mechanical interface configured, upon coupling to a drive configured so that a reciprocating motion of the drive is transmitted to the shaft, and the cartridge assembly is removable and replaceable independent of the body housing.

According to another aspect, a method of decorating leather that comprises stamping leather with a shaft on a device, wherein the device has an electric drive; and adjusting the voltage to the electric drive, wherein adjusting the voltage changes a rate of reciprocation of the electric drive and the shaft.

The following description and drawings disclose but a few of the various ways in which the principles of the subject disclosure may be employed. Some improvements and novel aspects may be expressly identified, while others may be apparent from the description and drawings.

### BRIEF DESCRIPTION OF THE DRAWINGS

The accompanying drawings illustrate systems, apparatuses, devices and methods, in which like-reference-characters refer to like parts throughout.

FIG. 1 illustrates a front view of the device, in accordance with various disclosed aspects;

FIG. 2 illustrates a perspective view of a cartridge and a distal portion of a shaft, in accordance with various disclosed aspects;

FIGS. 3A and 3B illustrate a front view of a cartridge and a distal portion of a shaft, in accordance with various disclosed aspects;

FIG. 4A illustrates a front view of a shaft including a distal portion and a proximal portion of the shaft, in accordance with various disclosed aspects;

FIG. 4B illustrates a front view of a shaft including a distal portion and a proximal portion of the shaft that is smaller in radial diameter than FIG. 4A, in accordance with various disclosed aspects

FIG. 5 illustrates a perspective view of a cartridge and a distal portion of a shaft, in accordance with various disclosed aspects;

FIG. 6A illustrates an exploded view of a cartridge and a shaft of FIG. 6B, in accordance with various disclosed aspects;

FIG. 6B illustrates a shaft housed within a cartridge, in accordance with various disclosed aspects;

FIG. 7 illustrates a perspective view of a cartridge and a distal portion of a shaft, in accordance with various disclosed aspects;

FIG. 8 illustrates a front view of a cartridge and a distal portion of a shaft, in accordance with various disclosed aspects;

FIG. 9A illustrates a perspective view of the drive housing, in accordance with various disclosed aspects;

FIG. 9B illustrates a top view of the drive housing, in accordance with various disclosed aspects;

FIG. 9C illustrates a bottom view of the drive housing, in accordance with various disclosed aspects;

FIG. 10 illustrates the device in use embossing tooling leather, in accordance with various disclosed aspects; and

FIG. 11 illustrates distal portions of the shaft exploded from the proximate portion of the shaft, in accordance with various disclosed aspects;

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION OF EMBODIMENTS

Reference will now be made in detail to exemplary embodiments of the present disclosure, examples of which are illustrated in the accompanying drawings. It is to be understood that other embodiments may be utilized, and structural and functional changes may be made without departing from the scope of the claims. Moreover, features of the various embodiments may be combined or altered without departing from the scope of the claims. As such, the following description is presented by way of illustration only and should not limit the various alternatives and modifications that may be made to the illustrated embodiments and still be within the spirit and scope of the claims.

As used herein, the words “example” and “exemplary” mean an instance or illustration. The words “example” or “exemplary” do not indicate a key or preferred aspect or embodiment. The word “or” is intended to be inclusive rather than exclusive, unless context suggests otherwise. For example, the phrase “A employs B or C” includes any inclusive permutation (e.g., A employs B; A employs C; or A employs both B and C). Further, the articles “a” and “an” are generally intended to mean “one or more” unless context suggests otherwise.

Unless specified otherwise, “first”, “second”, or the like are not intended to imply a temporal, spatial, or ordering aspect. Rather, such terms are merely used as identifiers or names for features, elements, or items. For example, a first channel and a second channel generally correspond to channel A and channel B or two different or two identical channels or the same channel. Additionally, “comprising”, “comprises”, “including”, “includes”, or the like generally means comprising or including, but not limited to.

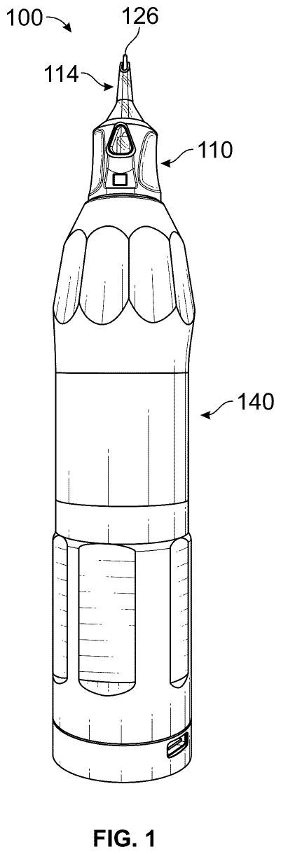

FIG. 1 illustrates a device 100. The device 100 includes a cartridge 110 that has a distal end 114 and a proximal end 115, and a shaft 120 that has a proximal portion 122 and a distal portion 124. The distal portion 124 has a distal tip 126. The proximal portion 122 extends from the distal portion 124 in a longitudinal direction as indicated by 128.

The device 100 further includes a drive 130 and a drive housing 140. The drive 130 may be electrically coupled to a motor. The drive 130 moves the shaft 120 in a reciprocating motion in a longitudinal direction 150.

The cartridge 110 may reversibly attach to the drive housing 140. The cartridge 110 may be of any usable shape that accepts and guides the shaft 120. The cartridge may include bearing/bushing guidance such as plain bushings (PTFE, PEEK, bronze), linear ball bushings, flexure-guided shafts for zero play and low friction. The cartridge may include a distal end geometry specific to the shaft 120, for example: interchangeable nose cones with different apertures and stand-offs; a low-friction foot/skid to stabilize angle; or a roller foot to reduce drag. The cartridge 110 may be removably attachable via a threaded interface, bayonet coupling, magnetic retention, or collet chuck to enable rapid tip changes. The cartridge 110 may include a windows or means of illumination such as an integrated LED targeting ring or line, or a laser pointer for alignment. The cartridge 110 may include depth control including an adjustable depth stop collar; a micrometer ring to set maximum protrusion; and/or a ratcheting detent for coarse settings. The cartridge 110 may include angle control including an articulating wrist or ball joint at distal end; a removable angle guide wedges; and/or a perpendicular standoff for vertical stamping.

The cartridge 110 may include a vacuum/air assist including small vacuum ports to hold thin leather flat; and/or a air-jet to clear debris and cool tip. The cartridge 110 may include noise/vibration control mechanism including an internal acoustic lining; a mass tuning; and/or an isolating interface between cartridge and housing.

The device 100 may be driven by a variety of drive types and rotary-to-linear conversions. Drive types may include electric DC/BLDC motor; stepper motor; linear voice-coil actuator; solenoid actuator; piezoelectric stack/ultrasonic actuator; pneumatic actuator (air hammer); hydraulic micro-actuator; shape memory alloy actuator for low-force applications. The device 100 may also have a motion conversion options including eccentric cam and follower; Scotch yoke; crank-slider; wobble plate; swashplate; planetary cam; ball-screw with reciprocating reversal; magnetic linear oscillation; hammer/anvil impact (with compliant intermediary). In certain embodiments, the reciprocating motion may be generated by a solenoid, a pneumatic actuator, a piezoelectric stack, or a voice-coil actuator, each operatively coupled to the shaft by a cam, crank-slider, Scotch yoke, or equivalent motion conversion.

A biasing element such as a compression spring, torsion spring, elastomeric member, or magnetic return may bias the shaft toward a retracted position.

The device 100 may have stroke management including fixed stroke; adjustable stroke via movable eccentric/throw; electronically controlled stroke using a linear actuator stop; interchangeable cams of different profiles (e.g., dwell-at-bottom for deeper impressions). The device 100 may have frequency control including voltage or PWM control; closed-loop RPM via hall sensors; duty-cycle modulation; multi-speed gearboxes for torque/frequency trade-offs.

The distal tip 126 of the distal portion 124 may be blunt. In an embodiment, the distal tip 126 may facilitate stamping, embossing, or pushing down the surface of the tooling leather without cutting the surface of the leather. Herein blunt means edgeless or lacking a beveled, cutting edge. A blunt tip has a working edge that is generally rounded and not intended to slice or incise leather. A blunt tip compresses and displaces the surface rather than penetrating it. In practice, a blunt tip leaves an impression with soft, rounded shoulders and no cut line. The distal tip 126 of the shaft 120 may selectively extend beyond the distal end 114 of the cartridge 110 in a stamping position when driven by the drive 130 where it may make contact with leather (e.g., if the device 100 is positioned by the user such that the distal tip 126 makes contact with a surface 90 of the leather). The distal tip 126 of the shaft 120 may further selectively retract into the distal end 114 of the cartridge 110 in a retracted position where it may not make contact with leather or where the distal tip 126 of the shaft 120 may be otherwise covered by the distal end 114 of the cartridge 110. For example, the distal tip 126 may be in the retracted position when the device 100 is turned off. For example, the distal tip 126 may be in the retracted position when the cartridge 110 is not coupled to the drive 130. In an embodiment, the distal tip 126 may be biased to the retracted position.

A radial dimension 155 of the distal tip 126 controls the diameter of the stamp made in the tooling leather. The radial dimension of the distal tip 126 shown in the drawings range in size from 0.015 to 0.02 inches, however, distal tips may range in radial dimension from 0.005 to 0.15 inches. Continuing to refer to FIG. 1, the distal tip 126 shown at 0.015 inches may be used to create an indent in the leather of a smaller radial dimension than the 0.02 inch distal tip 126. Furthermore, a distal tip 126 of either size may be used to make lines in the surface 90 of leather or emboss portions of the surface 90 of leather; see FIG. 10.

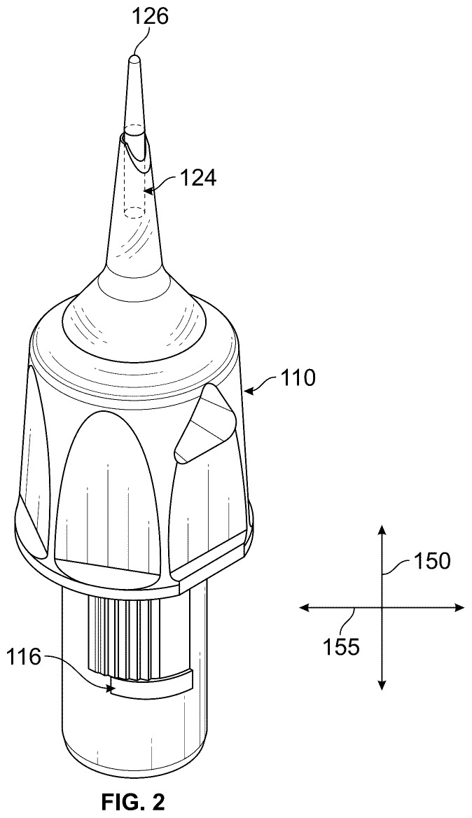

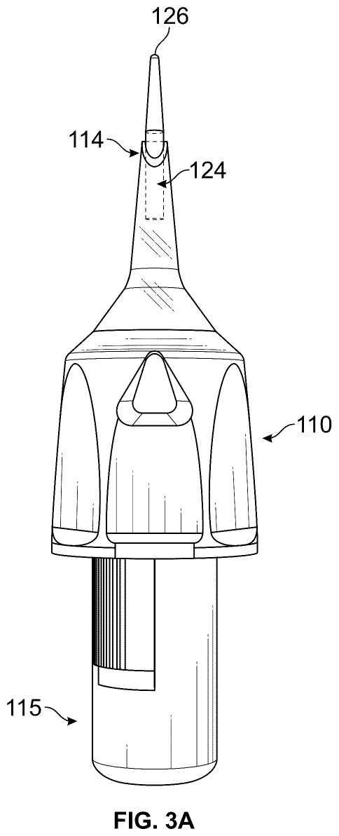

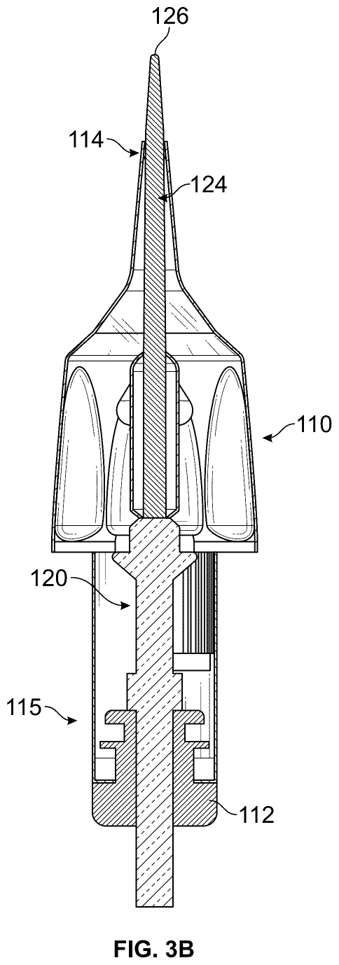

Now referring to FIGS. 2 and 3 which show an embodiment of the distal tip 126 of the shaft 120 with a radial dimension of 0.015 inches. The shaft 120 is housed within a cartridge 110 with the distal tip 126 and a section of the distal portion 124 of the shaft 120 extending beyond the distal end 114 of the cartridge 110. The distal tip 126 may be blunt, as shown in the drawings. The cartridge 110 has projections 116 in a radial dimension 155. The projections 116 are configured to selectively couple to the drive housing 140 such that the drive 130 makes contact with the shaft 120 and moves the shaft 120 in the reciprocating motion when the drive 130 is active.

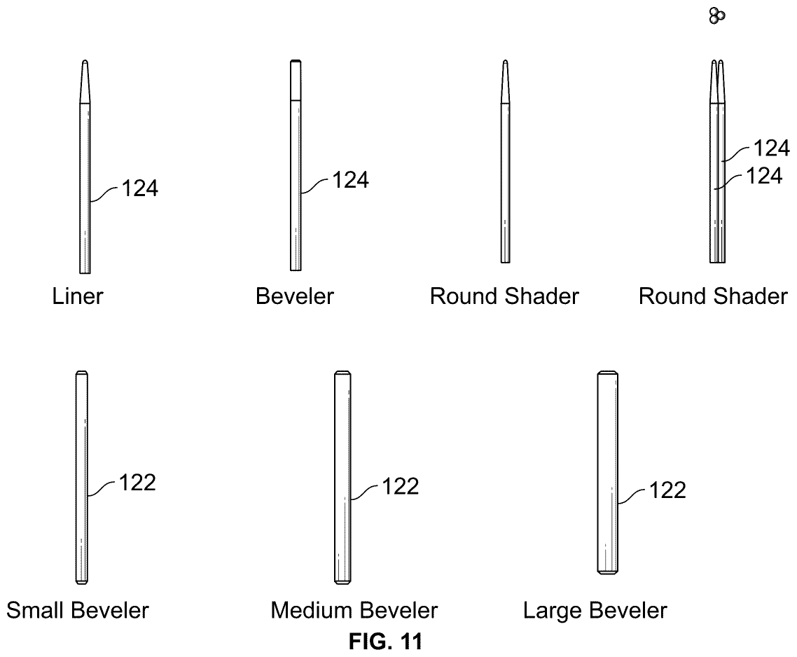

The distal tip 126 may include structures that result in blunt stamping effects. For example, the distal tip 126 may have different tip geometries including a flat face; a spherical radius; domed/ogival; a chamfered edge with rounded corner radius; a knurled/micro-textured face; a patterned micro-relief; a ring-shaped annular face; a multi-facet polygonal flats; a liner; a beveler; a round shader (as shown in FIG. 11); and an elliptical footprint for line variation. The distal tip 126 may include different array setups including a linear array; a 2D matrix; a staggered array; a radially symmetric cluster; independently sprung multi-tips to conform to curvature; and replaceable cartridge plates carrying arrays.

The distal tip 126 may comprise or be coated with a hardened tool steel; tungsten carbide; ceramics (e.g., alumina) for wear; PEEK or UHMW-PE for delicate leathers; DLC, TiN, or CrN coatings for wear/low friction; polished vs matte finishes to tune drag; and low-stick fluoropolymer sleeves for oily leathers.

The distal tip 126 may include a resistive micro-heater or cartridge heater integrated in the tip or near the distal end, with temperature control to thermally assist embossing without cutting.

In an alternative embodiment, the shaft 120 may selectively couple with the drive 130 via a rigid, flexible, sleeve, split muff, flange, gear, universal, oldham, jaw, or beam coupling. The device 100 may include a quick-change system including a one-touch cartridge release with electrical and mechanical blind-mate; and/or a keyed or asymmetric interfaces to ensure orientation. The device 100 may include torque/impact isolation such as an elastomeric spider coupling; a diaphragm coupling for misalignment; and/or a torque-limiting clutch to protect delicate tips. The device 100 may include a remote handpiece such as a flexible drive shaft from a bench motor to a lightweight pen; or an umbilical cord for power/controls to reduce hand mass.

The device 100 may include control systems and sensing that improves results such as a tip position sensing (Hall, optical, LVDT); a force sensing at tip or in line (strain gauge, piezoelectric force washer); a contact detection system; and/or a temperature sensing for heated tips. The device 100 may include a closed-loop control such as one that maintains constant impact energy or force; a constant stroke despite load; and/or an auto-compensation for leather hardness. The device 100 may include a user interface that has presets for leather weight (oz), pattern modes (continuous line, dotted line at fixed pitch); or a lockout for novice mode; a foot pedal or a finger trigger. The device 100 may include waveforms control of the motor shaft movement including a burst mode (N impacts per trigger), variable dwelling at bottom dead center via cam or electronic shaping; and/or a randomized micro-jitter to avoid moiré.

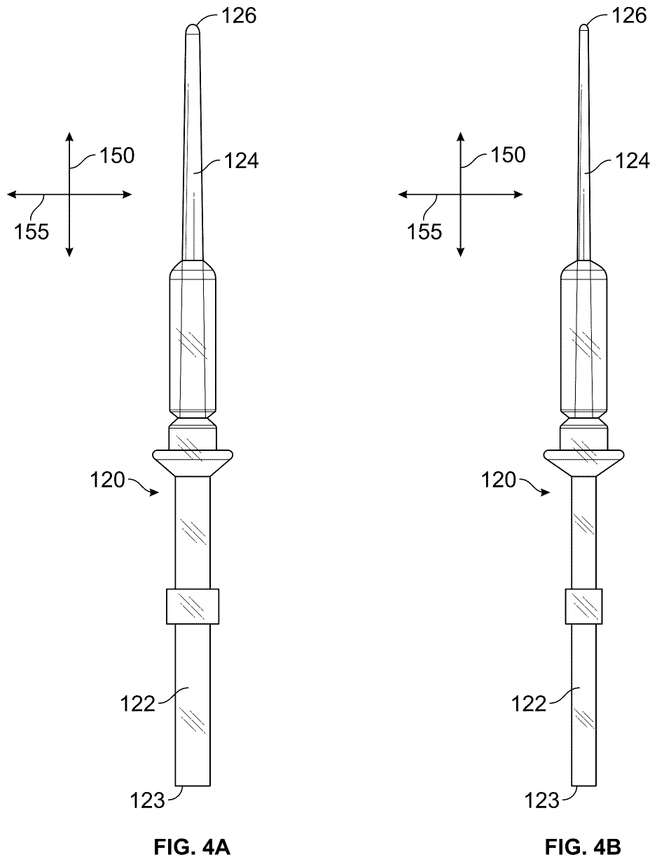

FIG. 4 shows an embodiment of the shaft 120, with the distal portion 124 having the distal tip 126. The shaft 120 also has a proximal portion 122. The distal tip 126 as shown in FIG. 4 is blunt. The proximal portion 122 of the shaft 120 has a proximal end 123 that makes contact with the drive 130. The shaft 120 in the embodiment shown in FIG. 4 and FIG. 11 measures 2.35 inches. The shaft 120 may be larger or smaller than 2.35 inches without departing from the scope of the disclosure. In embodiments, the length of shaft 120 is proportionately longer than the length of the cartridge 110.

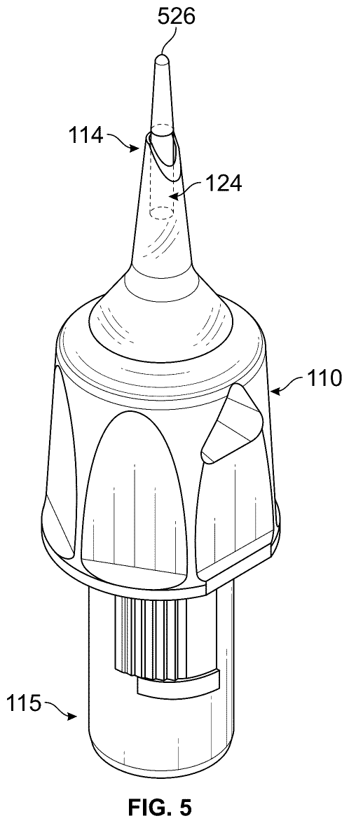

FIG. 5 shows a distal tip 526 of the shaft 120 with a radial dimension of 0.015 inches housed within the cartridge 110. The distal portion 124 of a shaft 120 extending beyond the distal end 114 of the cartridge 110. The distal tip 526 may be blunt as shown in FIG. 5 and may have a radial dimension of 0.02 inches.

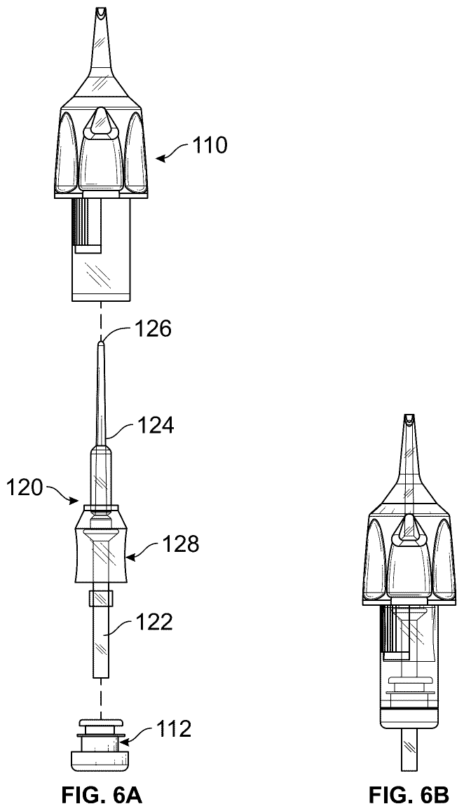

FIG. 6A shows an embodiment of the shaft 120 with the distal portion 124 and the proximal portion 122. The distal portion 124 has the distal tip 126 that is blunt in FIG. 6A & B. FIG. 6A shows the cartridge 110 and an end-cap 112. The end-cap 112 configured to hold the shaft 120 in place within the cartridge 110 when the shaft 120 and the cartridge 110 are assembled, as shown in FIG. 6B. The shaft 120 has a membrane 128 that connects to the end-cap 112. The membrane 128 stretches when the drive 130 pushes the shaft 120 in a longitudinal direction 150 away from the drive housing 140, and the stretched membrane 128 provides energy that pulls the shaft 120 toward the drive housing 140 in the longitudinal direction 150. The cartridge shown in FIG. 6A is 1.955 inches. Alternative embodiments may be larger or smaller than 1.955 inches.

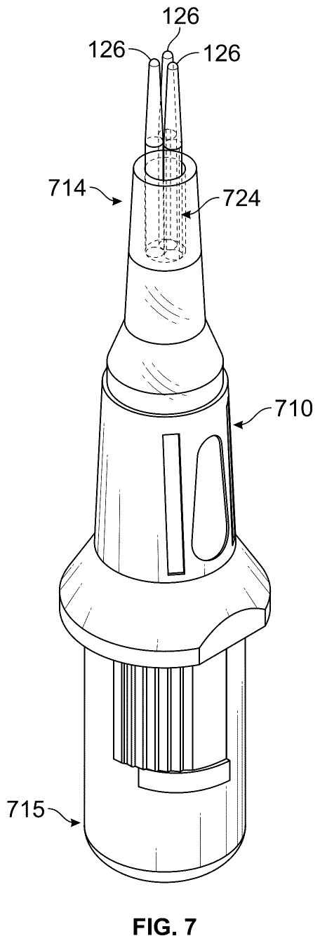

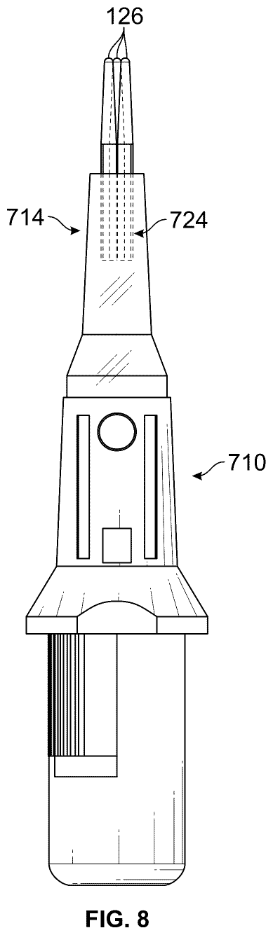

FIGS. 7 and 8 show an embodiment of a cartridge 710 with a distal end 714. The cartridge 710 houses the shaft 120 with a distal portion 724 that contains three distal tips 126. The three distal tips 126 may be of the same size as those in a single distal tip embodiment.

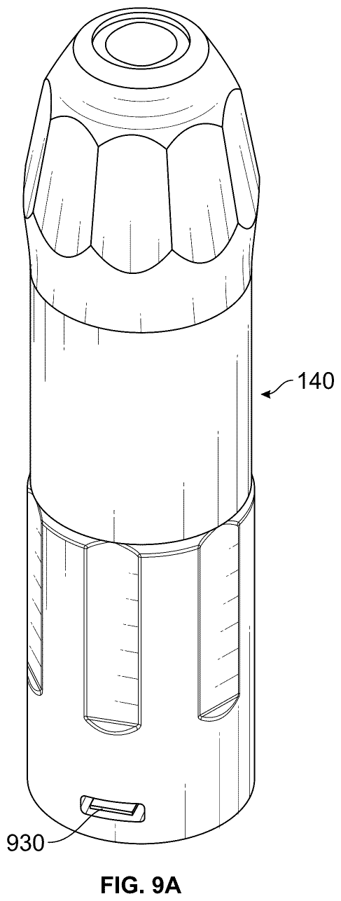

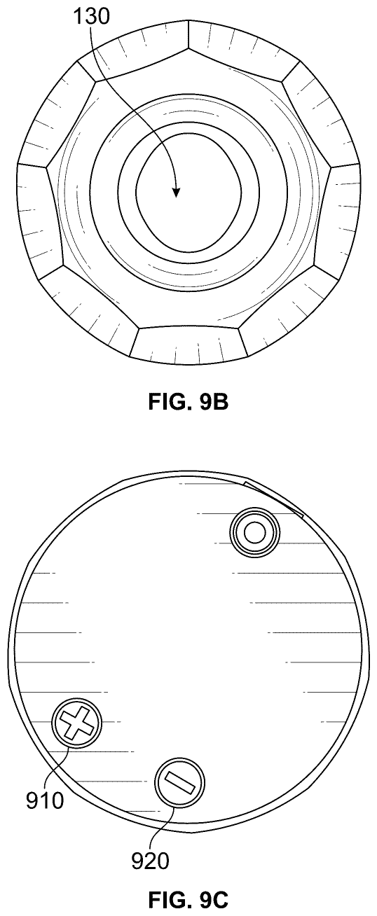

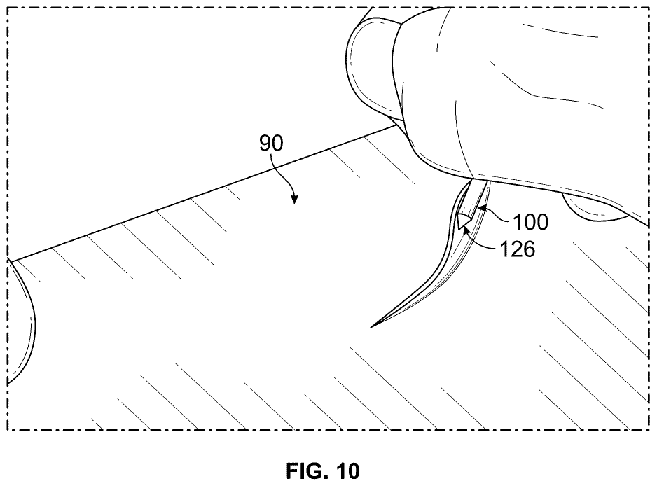

FIG. 9 illustrates an embodiment of the drive housing 140. An embodied drive housing 140 may be structured to provide an ergonomic surface for the human hand and to accommodate the drive 130. The drive housing 140 has a voltage-up button 910 and a voltage-down button 920 that allows a user to change the voltage to the drive 130, thereby changing the speed of the drive 130.

The cartridge 110/710 may be relatively tapered from the distal end 114/714 to the proximal end 115/715. The distal end 114/714 has a radial dimension 155 that is slightly larger than the radial dimension 155 of the shaft 120, configured to support the shaft 120 and the distal tip 126 when pressure is applied by a user embossing leather. As shown in FIG. 10, the device 100 may be at an acute angle to the leather surface 90 when in use, as viewed by a user (e.g., like a pencil). The user can alternatively approach the leather surface 90 with the device relatively perpendicular to the leather surface 90. The proximal end 115/715 of the cartridge 110/710 has a wider radial dimension than the distal end 114/714; the drive housing 140 accepts the proximal end 115/715 for connection to the drive 130. The cartridge 110 may have a window configured to allow the user to view the shaft 120.

The shaft 120 may be unitary or may be constructed from at least two pieces that are coupled. The shaft 120 may be made of metal, plastic, or a composite. The shaft 120 may be hollow or solid, however, the distal tip 126 is blunt and solid in the radial dimension.

The drive 130 and/or the drive housing 140 has a charging port 930 to charge a battery housed inside the device and/or drive housing 140.

The drive housing 140 may be made of metal, plastic, or composite. The drive housing 140 may be ergonomically shaped to accept the hand of a user. The shape of the drive housing 140 may position the user's wrist at an angle that reduces fatigue during use of the device 100.

The device 100 allows a user with limited experience and no mastery of working leather to decorate leather. Manually-driven leather decorating tools often require the use of a cutting edge or blade, posing a safety risk. Manually-driven leather decorating tools that emboss leather often require application of substantial forces to the tool and the leather to accomplish decoration of the leather. The device 100 disclosed herein allows a user to decorate leather without the use of a cutting edge or sharp blade. In addition, the drive 130 provides most of the energy required to decorate the leather and is therefore less physically strenuous for a user than manually-driven leather embossing tools.

The device 100 may include a retractable tip interlocked to power; a proximity guard at distal end; an over-temp and over-current cutoffs; and/or a child lock. For ergonomics, the device 100 may have multiple grip sizes; an adjustable balance via removable counterweights; a soft-touch overmolding; and/or a left/right bias variants.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed to imply that these operations are necessarily order dependent. Alternative ordering will be appreciated based on this description. Further, not all operations may necessarily be present in each aspect provided herein.

It will be appreciated that various of the above-disclosed and other features and functions, or alternatives or varieties thereof, may be desirably combined into many other different systems or applications. Also, various presently unforeseen or unanticipated alternatives, modifications, variations, or improvements therein may be subsequently made by those skilled in the art which are also intended to be encompassed by the following claims.

1. A device for decorating leather comprising:
a cartridge that has a distal end;
a shaft that has a proximal portion and a distal portion, the distal portion has a distal tip configured to tool leather and the proximal portion extends from the distal portion in a longitudinal direction;
a drive that is configured to move the shaft in a reciprocating motion, and
a drive housing configured to house the drive and be held by a user,
wherein if the device is assembled, the shaft is housed within the cartridge, the distal tip of the shaft extends distally beyond the distal end of the cartridge, and the cartridge is attached to the drive housing.

2. The device of claim 1, wherein the distal portion of the shaft is a first distal tip.

3. The device of claim 2, further comprising a second distal tip and a third distal tip.

4. The device of claim 1, wherein the distal tip is blunt such that it is edgeless and configured to compress or displace a leather surface without cutting.

5. The device of claim 1, wherein the drive comprises an electric motor configured to reciprocate the shaft, and the drive housing comprises user controls to adjust voltage or PWM to change a rate of reciprocation.

6. The device of claim 1, wherein the shaft is unitary or comprises at least two coupled pieces and is made of metal, plastic, or a composite, and wherein the distal tip is solid in radial cross-section.

7. The device of claim 1, wherein the distal tip comprises or is coated with a material selected from hardened tool steel, tungsten carbide, a ceramic, PEEK, UHMW-PE, DLC, TiN, or CrN.

8. The device of claim 1, wherein the shaft is biased toward a retracted position by a biasing element selected from a compression spring, a torsion spring, an elastomeric member, a magnetic return, or a membrane.

9. The device of claim 7, wherein the shaft is operatively connected to an end-cap of the cartridge by a membrane configured to stretch when the drive moves the shaft distally and to return energy that pulls the shaft proximally.

10. The device of claim 1, wherein the cartridge is removably attachable to the drive housing by a threaded interface, a bayonet coupling, a magnetic retention feature, or a collet chuck.

11. The device of claim 1, wherein the cartridge comprises projections configured to selectively couple to the drive housing such that the drive contacts the shaft when the cartridge is attached.

12. The device of claim 1, wherein the cartridge comprises a depth control feature including an adjustable depth stop collar, a micrometer ring to set maximum protrusion of the distal tip, or a ratcheting detent.

13. The device of claim 1, wherein the cartridge comprises a window configured to allow a user to view the shaft and/or comprises an illumination feature including an LED targeting ring, an LED line, or a laser alignment pointer.

14. The device of claim 1, wherein the device comprises a user interface providing one or more presets including leather weight, pattern modes comprising a continuous line or a dotted line at a fixed pitch, a novice lockout, or a burst mode with a predetermined number of impacts per trigger.

15. The device of claim 1, wherein the device comprises one or more sensors selected from a tip position sensor, a force sensor, a contact detection sensor, or a temperature sensor, and control circuitry responsive to the one or more sensors.

16. The device of claim 1, wherein the shaft has a length greater than a length of the cartridge.

17. A cartridge assembly for a leather-decorating tool, comprising:
a cartridge having a proximal end configured to couple to a body housing and a distal end configured to be positioned adjacent a leather work surface;
a shaft disposed within the body housing and movable along a longitudinal axis between a retracted position and an extended position;
a distal portion of the shaft that is configured as a distal tip carried by, when extended, to project distally beyond the distal end of the cartridge to deform a leather without cutting; and
a return bias element within the cartridge engaging the shaft and urging the shaft toward the retracted position;
wherein the proximal end of the cartridge includes a mechanical interface configured, upon coupling to a drive configured so that a reciprocating motion of the drive is transmitted to the shaft, and the cartridge assembly is removable and replaceable independent of the body housing.

18. The cartridge of claim 12, further comprising a user-adjustable depth control disposed on the cartridge and configured to set a maximum distal projection of the distal tip or the distal tip relative to the distal end of the cartridge.

19. A method of decorating leather, comprising:
stamping leather with a shaft on a reciprocating device, wherein the reciprocating device has an electric drive; and
adjusting a voltage to the electric drive, wherein adjusting the voltage changes a rate of reciprocation of the electric drive and the shaft.

20. The method of claim 19, further comprising selecting a cartridge and a shaft based on a user's decorating intent.
